(19) United States
(12) Patent Application Publication
(10) Pub. No.: US 2013/0138021 A1
(43) Pub. Date: May 30, 2013

(54) DIGITAL INSTRUMENT FOR USE IN PHYSICAL THERAPY AND METHOD FOR ADMINISTERING PHYSICAL THERAPY USING SAME

(71) Applicants: Daniel Mikesell, Yeongi-gun (KR); Hyoen-Hui Kim, Cheongju-si (KR)

(72) Inventors: Daniel Mikesell, Yeongi-gun (KR); Hyoen-Hui Kim, Cheongju-si (KR)

(21) Appl. No.: 13/816,409

(22) PCT Filed: Sep. 13, 2010
(86) PCT No.: PCT/KR10/06217

§ 371 Date: Feb. 11, 2013

(30) Foreign Application Priority Data
Aug. 9, 2010 (KR) 10-2010-0076532

(51) Int. Cl. A61H 99/00

(52) U.S. Cl. CPC A61H 99/00
USPC 601/40

(57) ABSTRACT

The present invention relates to a digital instrument for use in physical therapy, including a gripping force measurement bar which measures the gripping force of a hand when the bar is grasped, a sensor portion which measures the rotation of a wrist when the wrist is turned while the gripping force measuring bar is grasped, a display device which visually displays the degree of the gripping force or the extent to which the wrist is rotated, and a memory portion which stores the degree of the gripping force of a measured value relating to the rotation of the wrist. The invention also relates to a physical therapy method using the instrument. According to the present invention, the degree of motion is assessed on a real-time basis, the degree of motion is easily controlled, and an exercise activity is rendered more interesting since the degree of the gripping force or the extent to which the wrist is rotated is measured and visually displayed.

### TECHNICAL FIELD

The present invention relates to a digital instrument for use in physical therapy and a method for administrating physical therapy using the same, in particular, the present invention relates to a digital instrument for use in physical therapy which can measure the gripping force and the rotation of a wrist and a method for administrating physical therapy using the same.

### BACKGROUND ART

Generally, a hand gripper compresses a spring between handles with the force exerted by the user grasping the handles. The user uses a hand gripper to strengthen his/her gripping force.

However, many of the springs of conventional hand grippers are so strong that they cause pain to the users' hands and/or make the users to abort exercise. In addition, since the degree of gripping force cannot be checked, it is difficult to control the intensity of exercise.

In addition, since the physical effect of conventional hand grippers is limited to hands and arms, the users may lose interest in exercising.

### CONSTRUCTION OF THE INVENTION

### Technical Objects

The present invention provides a digital instrument for use in physical therapy and a method for administrating physical therapy using the same. According to the present invention, the degree of motion is assessed on a real-time basis, the degree of motion is easily controlled, and an exercise activity is rendered more interesting since the degree of the gripping force or the extent to which the wrist is rotated is measured and visually displayed.

### Means for Achieving the Technical Object

The present invention relates to a digital instrument for use in physical therapy, including a gripping force measurement bar which measures the gripping force of a hand when the bar is grasped, a sensor portion which measures the rotation of a wrist when the wrist is turned while the gripping force measuring bar is grasped, a display device which visually displays the degree of the gripping force or the extent to which the wrist is rotated, and a memory portion which stores the degree of the gripping force of a measured value relating to the rotation of the wrist.

Here, the gripping force measuring bar is provided with a first block and a second block at the both ends, forming a dumbbell, and the display devices formed on the surface of the first block or the second block displays the degree of the gripping force by color tones.

In addition, the display devices can be LEDs having different color tones, formed in a ring shape with relation to the circumferential direction of the first block or the second block corresponding to the circumference of the gripping force measuring bar, at an interval along the axial direction of the gripping force measuring bar.

In addition, the digital instrument for use in physical therapy can further comprise a communicator which transmits the identifier code for user identification or the measurement data stored in the memory portion to an external control server.

In addition, the sensor portion can further comprise a tilt sensor which determines whether the gripping hand is the left hand or the right hand by detecting the tilting angle of the gripping force measuring bar, the tilt angle which is formed by the shape of the palm of the hand gripping the gripping force measuring bar, and the measurement value can be saved separately classified by left hand and right hand.

In addition, the control server stores the physical condition of the user corresponding to the identifier code and the appropriate quantity of exercise according to the physical condition of the user, and can transmit the appropriate quantity of exercise of the gripping force or the degree of wrist rotation corresponding to the physical condition of the user to the communicator.

Here, the display device can display color codes differentiated by the statuses where the degree of the gripping force or measurement value of the angle of the rotation of a wrist of the user is: less than the appropriate quantity of exercise; equal to the appropriate quantity of exercise; and above the appropriate quantity of exercise.

In addition, the present invention provides a method for physical therapy using the digital instrument, the method comprising the steps of: transmitting the identifier code for user identification to an external control server; saving the degree of the gripping force or the degree of rotation of a wrist by the exercise of the user on a real-time basis; transmitting the history of the measurement values, if the measurement value fails to be saved for a preset time period, to the control server in link with the identifier code; receiving the result of the comparison between the measurement value and the appropriate quantity of exercise corresponding to the physical condition from the control server which is storing the physical condition of the user identified by the identifier code; and displaying color codes differentiated by the statuses where the measurement value is less than the appropriate quantity of exercise, equal to the appropriate quantity of exercise, or above the appropriate quantity of exercise.

In addition, the present invention provides a method for physical therapy using the digital instrument, the method comprising the steps of: transmitting the identifier code for user identification to an external control server; receiving the appropriate quantity of exercise corresponding to the physical condition from the control server which is storing the physical condition of the user identified by the identifier code; measuring the degree of the gripping force or the degree of rotation of a wrist by the exercise of the user; comparing the measurement value with the appropriate quantity of exercise; and displaying color codes differentiated by the statuses where the measurement value is less than the appropriate quantity of exercise, equal to the appropriate quantity of exercise, or above the appropriate quantity of exercise.

### Effect of the Present Invention

The digital instrument for use in physical therapy and the method for physical therapy using the same in accordance with the present invention allow the user to monitor the degree of exercise on a real-time basis and control the degree of exercise easily, and the exercise activity is rendered more interest since the degree of the gripping force or the extent to which the wrist is rotated is measured and visually displayed.

### BRIEF DESCRIPTION OF THE DRAWINGS

FIG. 1 is an elevation view of the digital instrument for use in physical therapy in accordance with an embodiment of the present invention.

FIG. 2 is a left hand side view and a right hand side view of the instrument of FIG. 1.

FIG. 3 is a perspective view of the instrument of FIG. 1 when grasped by the right hand.

FIG. 4 shows a graph of the average gripping force measured on a daily basis using the instrument of FIG. 1.

FIG. 5 is a flow chart describing an exemplary method for the physical therapy using the instrument of FIG. 1.

FIG. 6 is a flow chart describing another exemplary method for the physical therapy using the instrument of FIG. 1.

### DESCRIPTION OF THE PREFERRED EMBODIMENT OF THE INVENTION

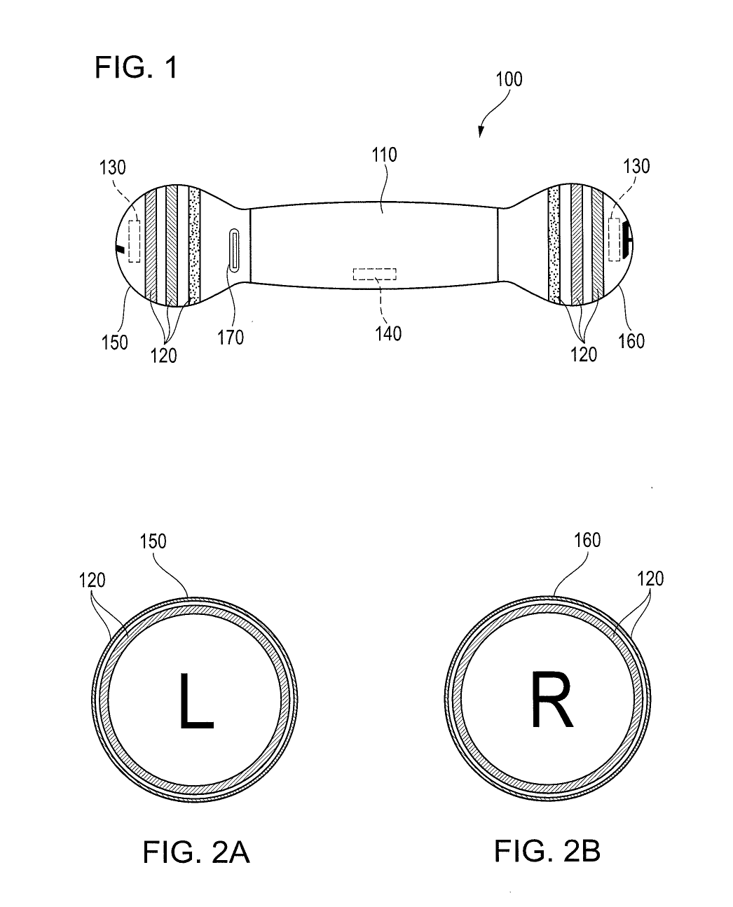

FIG. 1 is an elevation view of the digital instrument for use in physical therapy in accordance with an embodiment of the present invention. FIG. 2 is a left hand side view and a right hand side view of the instrument of FIG. 1.

Referring to FIG. 1 and FIG. 2, the digital instrument for use in physical therapy 100 comprises a gripping force measuring bar 110, a sensor portion 130, display devices 120, a memory portion 140, a first block 150, a second block 160, and a communication device 170.

The gripping force measuring bar 110 measures the degree of the gripping force when grasped by a hand. The gripping force is measured with a pressure sensor provided on the gripping force measuring bar 110.

The sensor portion 130 measures the extent of rotation of a wrist when the wrist is rotated while grasping the gripping force measuring bar 110 with a hand. The sensor portion 130 is provided with an accelerometer to measure the extent of the rotation of a wrist. The method of measuring the extent of the rotation of a wrist is not limited to the method set forth and described above, but can be implemented with a plurality of commonly acknowledged principles.

The display device 120 displays the degree of the gripping force or the extent of the rotation of a wrist in a visual way. Therefore, the user can monitor his/her quantity of exercise during exercising and be rendered with more interest in exercise.

The memory portion 140 saves the measurement values of the degree of the gripping force or the extent of the rotation of a wrist. The saved data is used for the later history inquiry and analysis of the quantity of exercise.

The gripping force measuring bar 110 is provided with the first block 150 and the second block 160 at both ends, forming a dumbbell shape. The display devices 120 provided on the surface of the first block 150 and the second block 160 indicate the degree of the gripping force by color codes.

In particular, the display devices 120 can be LEDs having different color tones, formed in a ring shape in relation to the circumferential direction of the first block 150 or the second block 160 corresponding to the circumference of the gripping force measuring bar 110, at an interval along the axial direction of the gripping force measuring bar 110. The embodiment shown in FIG. 1 and FIG. 2 is provided with three LEDs each indicating the state of strong, medium or weak.

For example, the three LEDs may be red, yellow and blue, where the red LED lights up if the measured gripping force is in the ‘Strong’ range, the yellow LED lights up if the measured gripping force is in the ‘Medium range, and the blue LED lights up if the measured gripping force is in the ‘Weak range.

Not limited to the above display scheme, the display devices 120 can be implemented to display the degree of gripping force of a hand or the extent of rotation of a wrist with figures or graphic format on the separate display screens (not shown in the drawings) formed on the first block 150 and the second block 160.

The sensor portion 130 further comprises a tilt sensor which determines whether the gripping hand is the left hand or the right hand by detecting the tilting angle of the gripping force measuring bar 110, the tilt angle which is formed by the shape of the palm of the hand gripping the gripping force measuring bar 110.

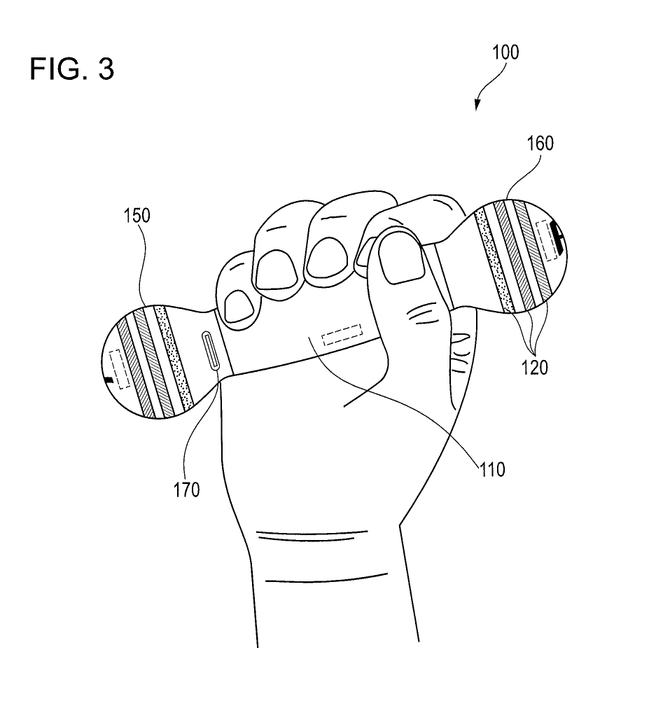

FIG. 3 is a perspective view of the instrument of FIG. 1 when grasped by the right hand. As a matter of fact, the tilting directions of the gripping force measuring bar 110 when grasped by the left hand and the right hand are opposite with each other, due to the differences in the shape of the palms and the lengths of the fingers.

The gripping force measuring bar in accordance with the present invention determines whether the hand currently grasping the bar is the left hand or the right hand by detecting the tilting direction. The memory portion 140 saves the measurement values measured during exercise classified into the left hand and the right hand. Here, in addition to saving the measurement values of the left and right hands, the counts of the motions for griping force and wrist rotation can also be saved.

Here, the digital instrument for use in physical therapy 100 is formed with the left and right markings to guide the correct gripping positions of the left and right hands. For example, the markings can be a character L formed on the first block 150 and R formed on the second block 160.

Table 1 below presents the data of an exemplary embodiment showing the counts of gripping force and wrist rotation exercises classified by the left and right hands and by date.

TABLE 1

| | | May 01 | May 02 | May 03 | May 04 | May 05 | May 06 | May 07 |
|---|---|---|---|---|---|---|---|---|
| Left | G. Force | 10 | 12 | 5 | 15 | 20 | 29 | 33 |
| Hand | W. Rotation | 30 | 22 | 20 | 35 | 30 | 40 | 43 |
| Right | G. Force | 12 | 15 | 17 | 10 | 25 | 30 | 39 |
| Hand | W. Rotation | 10 | 12 | 15 | 15 | 20 | 29 | 33 |

Needless to say, there can be many examples of data storage in the memory portion 140. For example, daily average values of exercise can be saved instead of the daily counts of exercise.

The communicating device 170 transmits the identifier code for user identification or the measurement data stored in the memory portion 140 to an external control server 10. Here, the communication method of the communication device 170 can be at least one of Wi-Fi, RF, or Bluetooth, as well as wired communication via a cable.

The communication device 170 shown in FIG. 1 has a USB socket for connection with a USB cable, however, the communication device in accordance with the present invention is not limited to the embodiment of FIG. 1. In addition, the USB socket can be used for back-up of the degree of the gripping force or the extent to which a wrist rotates by inserting a separate USB memory device, as well as communication with the control server 10.

The control server 10 can mean a space to which the user can access via a cellular phone or PC, via a wired or wireless network, or a server to which a doctor of a hospital accesses for treating patients via a wired or wireless network.

The control server 10 stores the physical conditions (e.g., height, weight, sex, age, disease history, etc.) and the optimal quantity of exercise of the user corresponding to the user's ID code. The physical conditions can include the conditions of the user's wrist, ligament and nerves near the wrist, or the progress of rehabilitation from an accident.

As such, the control server 10 transmits the gripping force or the appropriate quantity of exercise of wrist rotation corresponding to the physical condition to the communication device 170, after receiving the identifier code. Here, the appropriate quantity of exercise can be a daily, accumulated quantity of exercise as well as an instantaneous quantity of exercise measured once.

Here, the display device 120 can display color codes differentiated by the statuses where the degree of the gripping force or measurement value of the angle of the rotation of a wrist of the user is: (a) less than the appropriate quantity of exercise; (b) equal to the appropriate quantity of exercise; or (c) above the appropriate quantity of exercise. For example, the cases of (a), (b), and (c) can be indicated with a blue, a yellow and a red LED.

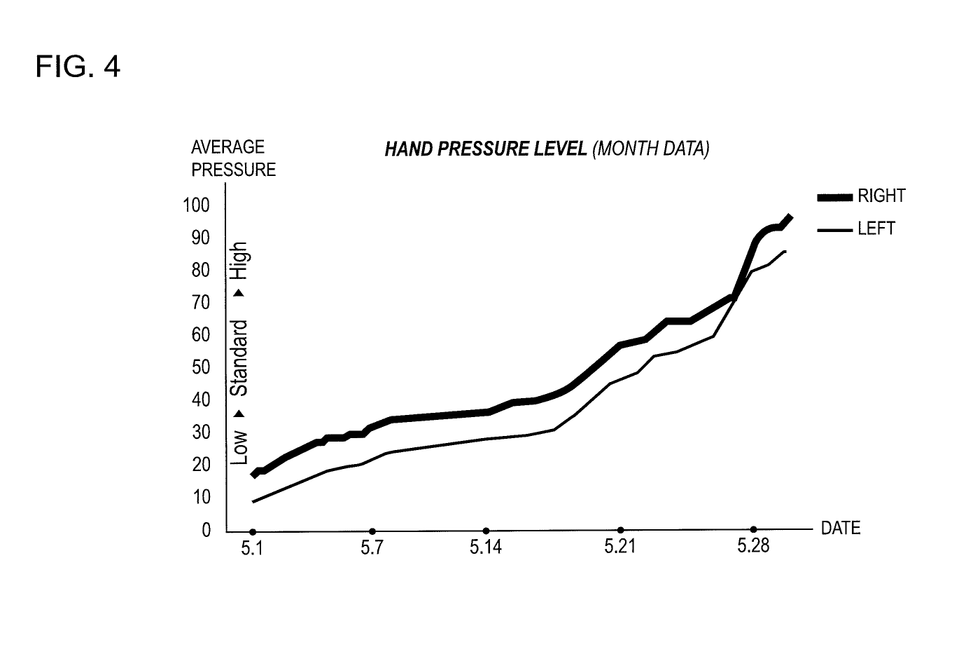

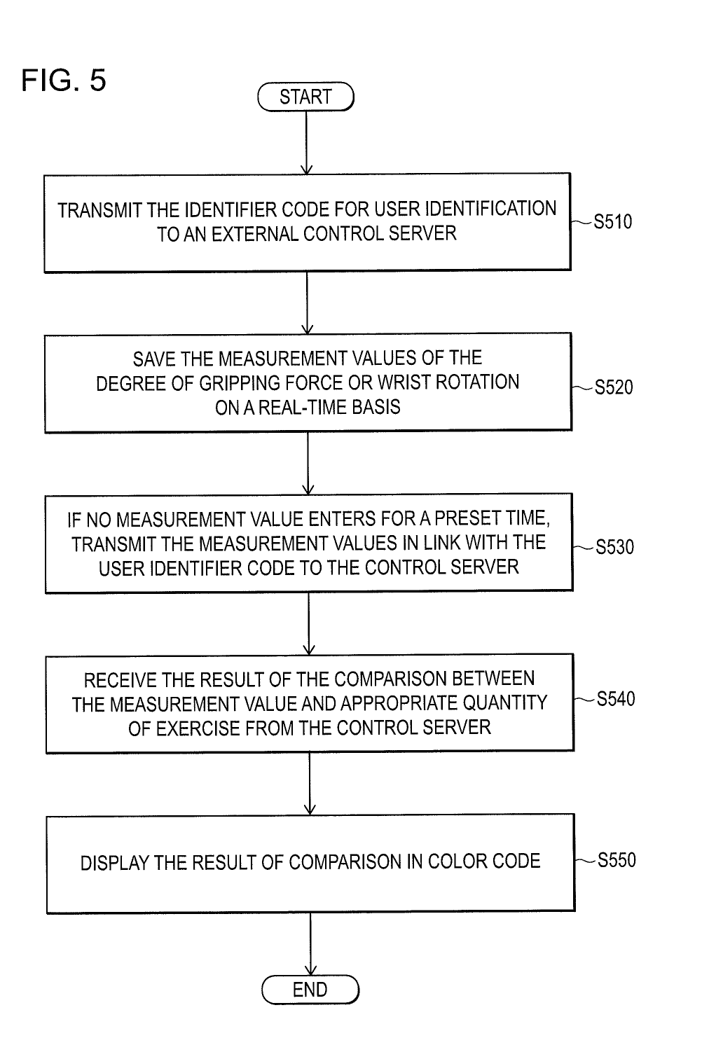

FIG. 4 shows a graph of the average gripping force measured on a daily basis using the instrument of FIG. 1. The statistics of the graph is processed by the control server 10. In the case of FIG. 5, the curves represent the daily averages of gripping force measured in May, for the left hand and the right hand respectively. The graph in FIG. 5 exemplifies a case where gripping force has been improved over time.

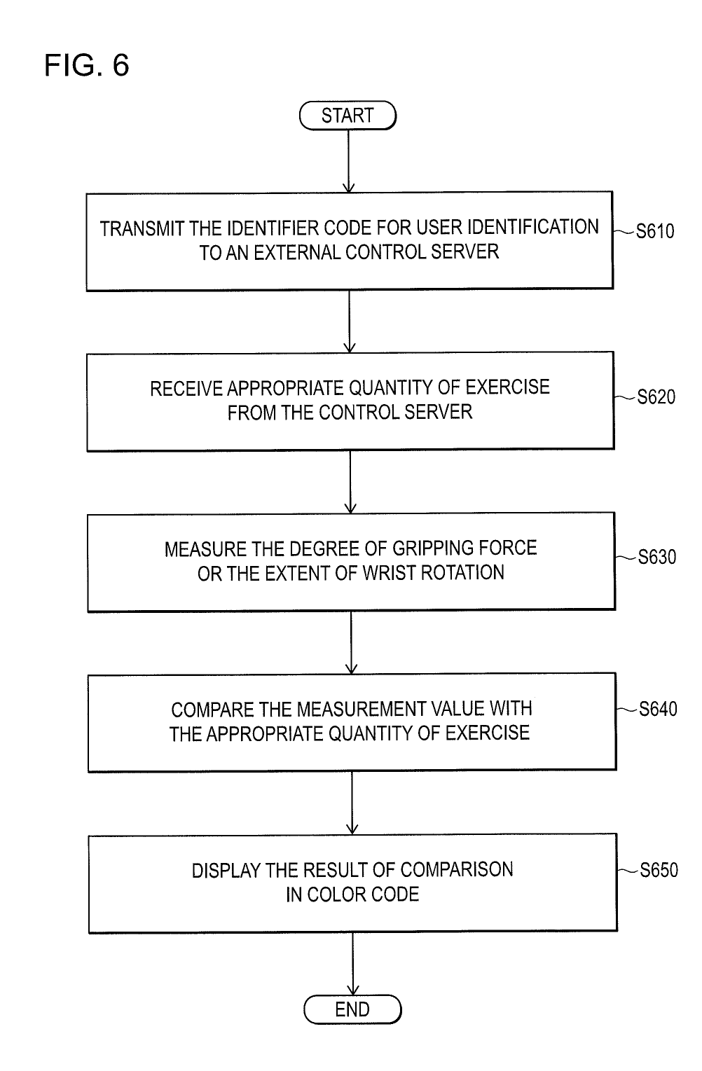

The method for physical therapy using the digital instrument 100 in accordance with the present invention is described below. FIG. 5 and FIG. 6 are the flow charts describing a first and a second exemplary methods for the physical therapy using the instrument of FIG. 1.

The first embodiment is as follows. First, the identifier code for user identification is transmitted to the external control server 10 via the communication device 170 in step S510. Then, the control server 10 recognizes the user.

Then, the degree of the gripping force or the extent to which the wrist rotates by the exercise of the user is saved in the memory portion 140 on a real-time basis, in step S520. If no measurement value is provided for a preset time, the instrument judges that the user has stopped exercise, and transmits the measurement data stored in the memory in link with the identifier code to the control server 10 via the communication device 170, in step S530.

The control server 10 has the physical condition data of the user identified by the identifier code. After then, the result of the comparison between the measurement values and the appropriate quantity of exercise corresponding to the physical conditions is received from the control server 10 via the communication device 170, in step S540.

Then, the display device 120 displays color codes differentiated by the statuses where measurement value is: less than the appropriate quantity of exercise; equal to the appropriate quantity of exercise; and above the appropriate quantity of exercise, in step S550. The exemplary operation of the display device 120 corresponding to step S550 was described earlier.

The embodiment described above further comprises a function which, after an exercise has been finished, judges whether the quantity of exercise had reached the level of the appropriate quantity of exercise by comparing the two. Here, the comparison and judgment are carried out by the control server 10, and the digital instrument for use in physical therapy 100 receives the result and informs the user of the judgment.

The second embodiment is as follows. First, the identifier code for user identification is transmitted to the external control server 10 via the communication device 170 in step S610. Then, the appropriate quantity of exercise corresponding to the physical condition of the user is received from the control server 10, in step S620. The reception is carried out by the communication device 170.

Then, the degree of the gripping force or the extent to which the wrist rotates is measured, in step S630. Then, the measurement value is compared with the appropriate quantity of exercise by the digital instrument for use in physical therapy 100, in step 640. The comparison is carried out on a real-time basis whenever gripping force of wrist rotation is measured.

Then, the display device 120 displays color codes differentiated by the statuses where measurement value is: less than the appropriate quantity of exercise; equal to the appropriate quantity of exercise; and above the appropriate quantity of exercise, in step S650.

The second embodiment described above further comprises a function which compares the measurement value with the appropriate quantity of exercise and indicates the result on a real-time basis. Here, different from the first embodiment, the comparison and judgment are carried out by the digital instrument for use in physical therapy 100, not the control server 10.

The present invention is described by referring to the accompanying drawings, it would be clear that a person skilled in the art can implement modified embodiments in various ways without departing from the spirit and scope of the present invention. Therefore, it will be understood that the appended claims are intended to cover all such modifications and embodiments which come within the spirit and scope of the present invention.

What is claimed is:

1. A digital instrument for use in physical therapy comprising:
a gripping force measuring bar which measures the gripping force of a hand grasping the bar;
a sensor portion which measures the extent to which the wrist of a hand rotates when the user rotates his/her wrist while grasping the gripping force measuring bar;
a display device which displays the degree of the gripping force or the extent of the rotation of a wrist in a visual way; and
a memory portion which saves the degree of the gripping force or the extent of the rotation of a wrist.

2. The digital instrument for use in physical therapy of claim 1, wherein the gripping force measuring bar is provided with a first block and a second block at both ends to form a dumbbell shape, and the display devices provided on the surface of the first block or the second block indicate the degree of the gripping force by color codes.

3. The digital instrument for use in physical therapy of claim 2, wherein the display devices can be LEDs having different color tones, formed in a ring shape with relation to the circumferential direction of the first block or the second block corresponding to the circumference of the gripping force measuring bar, at an interval along the axial direction of the gripping force measuring bar.

4. The digital instrument for use in physical therapy of claim 1, wherein the digital instrument for use in physical therapy can further comprise a communication devise which transmits the identifier code for user identification or the measurement data stored in the memory portion to an external control server.

5. The digital instrument for use in physical therapy of claim 4, wherein the sensor portion further comprises a tilt sensor which determines whether the gripping hand is the left hand or the right hand by detecting the tilting angle of the gripping force measuring bar, the tilt angle which is formed by the shape of the palm of the hand gripping the gripping force measuring bar; and the memory portion stores the measurement values by classifying them into the left hand and the right hand.

6. The digital instrument for use in physical therapy of claim 4, wherein the control server stores the physical conditions and the appropriate quantity of exercise of the user identified by the identifier code; and transmits the appropriate gripping force or extent of wrist rotation corresponding to the physical conditions of the user on receiving the user identifier code.

7. The digital instrument for use in physical therapy of claim 6, wherein the display device can display color codes differentiated by the statuses where the degree of the gripping force or measurement value of the angle of the rotation of a wrist of the user is: less than the appropriate quantity of exercise; equal to the appropriate quantity of exercise; and
above the appropriate quantity of exercise.

8. A method for physical therapy using a digital instrument, comprising the steps of:
transmitting the identifier code for user identification to an external control server;
saving the degree of the gripping force or the degree of rotation of a wrist by the exercise of the user on a real-time basis;
transmitting the history of the measurement values, if the measurement value fails to be saved for a preset time period, to the control server in link with the identifier code;
receiving the result of the comparison between the measurement value and the appropriate quantity of exercise corresponding to the physical constitution from the control server that stores the physical constitution of the user identified by the identifier code; and
displaying color codes differentiated by the statuses where the measurement value is less than the appropriate quantity of exercise, equal to the appropriate quantity of exercise, or above the appropriate quantity of exercise.

9. A method for physical therapy using a digital instrument, comprising the steps of:
transmitting the identifier code for user identification to an external control server;
receiving the appropriate quantity of exercise corresponding to the physical constitution from the control server that stores the physical constitution of the user identified by the identifier code;
measuring the degree of the gripping force or the degree of rotation of a wrist by the exercise of the user;
comparing the measurement value with the appropriate quantity of exercise; and
displaying color codes differentiated by the statuses where the measurement value is less than the appropriate quantity of exercise, equal to the appropriate quantity of exercise, or above the appropriate quantity of exercise.
